(19) United States
(12) Patent Application Publication
(10) Pub. No.: US 2013/0053061 A1
(43) Pub. Date: Feb. 28, 2013

(54) TERMINAL, LOCALIZATION SYSTEM, AND METHOD FOR DETERMINING LOCATION

(71) Applicants: Min Seok KANG, Seoul (KR); Hyeong Jae CHOI, Seoul (KR)

(72) Inventors: Min Seok KANG, Seoul (KR); Hyeong Jae CHOI, Seoul (KR)

(73) Assignee: PANTECH CO., LTD., Seoul (KR)

(21) Appl. No.: 13/591,887

(22) Filed: Aug. 22, 2012

(30) Foreign Application Priority Data
Aug. 26, 2011 (KR) 10-2011-0085881

(51) Int. Cl. H04W 24/00

(52) U.S. Cl. 455/456.1

(57) ABSTRACT

A localization system includes terminals and a server. The terminal includes an antenna unit to receive a wireless signals, a distance determining unit to determine a distance relative to other terminals using intensity information of the wireless signals, a direction detection unit to obtain an orientation of the terminal, and a control unit to control the terminal. The server includes a calculating unit to calculate a distance between the terminals based on intensity information, and a memory unit to store the distance information. The control unit may calculate a relative location of other terminals using a triangulation method based on the distance information between the terminals. The control unit may determine a location and orientation of another terminal based on a forward direction or orientation of the terminal obtained by the direction detecting unit of the terminal and the relative location of other terminals.

### CROSS-REFERENCE TO RELATED APPLICATION

This application claims priority from and the benefit of Korean Patent Application No. 10-2011-0085881, filed on Aug. 26, 2011, which is hereby incorporated by reference for all purposes as if fully set forth herein.

### BACKGROUND

1. Field

The following description relates to a terminal, a localization system, and method for determining location.

2. Discussion of the Background

Global Position Systems (GPS) is an existing outdoor localization system which uses intersection points of at least three imaginary circles to determine location of a terminal equipped with GPS. If circles are drawn based on three satellites where the radius may refer to a distance from each satellite to a point to be measured, three circles may intersect at one point, and this point may be recognized as the point to be measured. In other words, a triangulation method may be applied to the satellite generated circles.

Mobile devices may determine their own locations by using WiFi signals. WiFi Positioning System (WPS) may use a wireless access point (AP) list database (DB) to determine location of the mobile device. WPS use a wireless AP list DB for user terminals, such as mobile devices. In order to construct a wireless AP list DB, a vehicle (a scanning vehicle) equipped with a GPS may map or scan a geographic area and store a list of APs receiving a signal at one or more locations and the corresponding intensity of the signal. Various kinds of information (e.g., signal intensities varying along with the movement) received by the scanning vehicle may be combined to track the location of APs. The mobile device may refer to a constructed DB that stores a list of APs, which may be used to obtain information to determine its location by using a triangulation method based on at least three APs.

The triangulation method may use four points including the device whose location is to be found and three reference points for which location information may be available to determine location information of the device. If fewer than three reference points (i.e., locations of satellites) are available for the method, or if the information about at least one of the three reference points is not known, it may be difficult to calculate the location of the device with any accuracy. In addition, while a location based service (LBS) using base station information as a reference points may be used to determine a location of a mobile device subscribed to a mobile communication service, it may not easy to provide the existing LBS technique to devices not subscribed to the mobile communication service, such as some tablets, multimedia players, and other similar devices.

WPS may be used without receiving a mobile communication service, but the DB used to construct the WPS environment may be generated by a vehicle equipped with GPS device mapping or scanning an area. Therefore, in an area not reflected on the DB, it may not be easy to determine a location and/or a distance to a mobile device located in that area.

### SUMMARY

Exemplary embodiments of the present invention provide a terminal, localization system, and method for determining location.

Exemplary embodiments of present invention also provide a terminal, localization system, and method for determining location without the use of GPS.

Additional features of the invention will be set forth in the description which follows, and in part will be apparent from the description, or may be learned by practice of the invention.

An exemplary embodiment of the present invention discloses a first terminal, including: an antenna unit to receive a first wireless signal from a second terminal, a second wireless signal from a third terminal, and information about a third wireless signal transmitted between the second terminal and the third terminal; a distance determining unit to determine distance information of the second terminal and the third terminal with respect to the first terminal, wherein the distance information is determined according to an intensity of the first wireless signal and the second wireless signal; a direction detecting unit to determine an orientation of the first terminal; and a control unit to calculate locations of the second terminal and the third terminal based on the orientation of the first terminal and the distance information, and the information about the third wireless signal.

An exemplary embodiment of the present invention also discloses a localization system, including: a first terminal to receive a first set of wireless signals from a second terminal and a third terminal, and to determine distance information of the second terminal and the third terminal with respect to the first terminal according to the first set of wireless signals; the second terminal to receive a second set of wireless signals from the first terminal and the third terminal, and to determine a distance of the first terminal and the third terminal with respect to the second terminal according to the second set of wireless signals; the third terminal to receive a third set of wireless signals from the first terminal and the second terminal, and to determine a distance of the first terminal and the second terminal with respect to the third terminal according to the third set of wireless signals; and a server to receive determined distance information from each of the first terminal, the second terminal, and the third terminal, and to determine a location of the first terminal, the second terminal, and the third terminal.

An exemplary embodiment of the present invention also discloses a method for determining a location of a terminal, including: receiving, in a first terminal, a wireless signal from each of a second terminal, a third terminal; determining, in the first terminal, an intensity of the wireless signal received from the second terminal and an intensity of the wireless signal received from the third terminal; determining, in the first terminal, a distance to the second terminal according to the intensity of the wireless signal received from the second terminal, and a distance to the third terminal according to the intensity of the wireless signal received from the third terminal; determining an orientation of the first terminal; and determining locations of the second terminal and the third terminal based on the orientation of the first terminal, the distance to the second terminal, the distance to the third terminal, and a distance from second terminal to the third terminal received from one of the second terminal or the third terminal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a localization system according to an exemplary embodiment of the present invention.

FIG. 2 is a schematic diagram illustrating a localization method according to an exemplary embodiment of the present invention.

FIG. 3 is a flowchart illustrating a method for measurement of distance according to an exemplary embodiment of the present invention.

FIG. 4 is a flowchart illustrating a method for performing a distance measurement according to an exemplary embodiment of the present invention.

FIG. 5A is a table illustrating distance information according to an exemplary embodiment of the present invention.

FIG. 5B is a table illustrating distance information according to an exemplary embodiment of the present invention.

FIG. 5C is a table illustrating distance information according to an exemplary embodiment of the present invention.

FIG. 5D is a table illustrating distance information according to an exemplary embodiment of the present invention.

FIG. 6 is a table illustrating compensation distance data according to an exemplary embodiment of the present invention.

FIG. 7A is a schematic diagram illustrating a triangulation method based on compensation distance data according to an exemplary embodiment of the present invention.

FIG. 7B is a schematic diagram illustrating a triangulation method based on compensation distance data according to an exemplary embodiment of the present invention.

FIG. 7C is a schematic diagram illustrating a triangulation method based on compensation distance data according to an exemplary embodiment of the present invention.

FIG. 7D is a schematic diagram illustrating a triangulation method based on compensation distance data according to an exemplary embodiment of the present invention.

FIG. 8 is a schematic diagram illustrating a host terminal according to an exemplary embodiment of the present invention.

### DETAILED DESCRIPTION OF THE ILLUSTRATED EMBODIMENTS

Exemplary embodiments are described more fully hereinafter with reference to the accompanying drawings, in which exemplary embodiments of the invention are shown. This invention may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. In the drawings, the size and relative sizes of layers and regions may be exaggerated for clarity. Like reference numerals in the drawings denote like elements.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

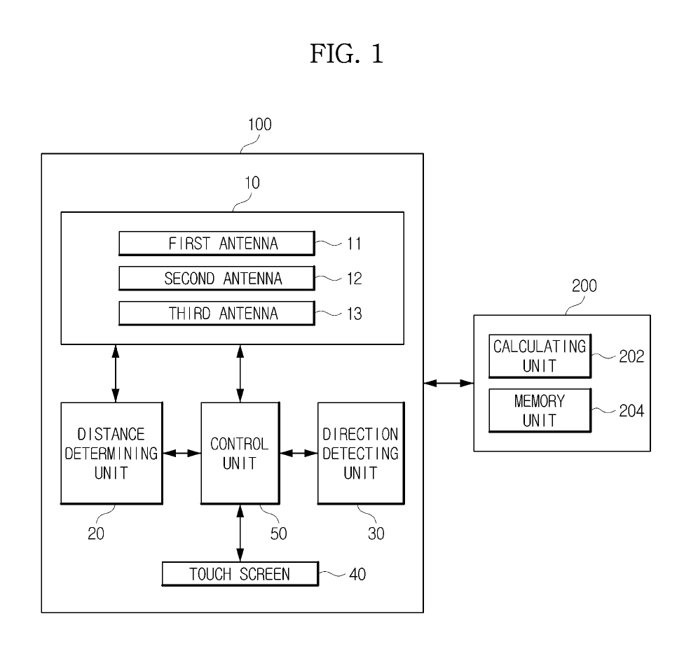

FIG. 1 is a schematic diagram of a localization system according to an exemplary embodiment of the present invention.

Referring to FIG. 1, a localization system includes at least one terminal 100 and a server 200.

The terminal 100 includes an antenna unit 10, a distance determining unit 20, a direction detecting unit 30, a touch screen 40, and a control unit 50.

The antenna unit 10 may be configured to receive wireless signals from other terminals and may include several antennas with different coverage ranges and different margins of error. In FIG. 1, the antenna unit 10 includes three antennas, including a first antenna 11, a second antenna 12, and a third antenna 13.

The first antenna 11 may be an antenna configured to receive a primary wireless signal which may have the smallest coverage range and the smallest margin of error of antennas in the antenna unit 10. The primary wireless signal may be a standard wireless signal with coverage range of 1 m or less and a margin of error less than 20 cm. The primary wireless signal may be a radio-frequency identification signal (RFID) and may have a band of approximately 443.92 MHz. However, the primary wireless signal is not limited RFID signal.

The second antenna 12 may be an antenna configured to receive a secondary wireless signal which may have a coverage range greater than that of the primary wireless signal and a margin of error lower than that of a third wireless signal, described below. The secondary wireless signal may be a standard wireless signal with coverage range less than 10 m and a margin of error less than 2 m. The secondary wireless signal may be a Bluetooth® Class 2 signal. However, the secondary wireless signal is not limited to the Bluetooth® Class 2 signal.

The third antenna 13 may be an antenna configured to receive a third wireless signal which may have a coverage range greater than that of the secondary wireless signal and a margin of error greater than that of the secondary wireless signal. The third wireless signal may be a standard wireless signal with a coverage range less than 100 m and a margin of error less than 10 m. The third wireless signal may be a signal conforming to an IEEE 802.11 standard (e.g., WiFi). However, the third wireless signal is not limited to the signal conforming to the IEEE 802.11 standard.

The distance determining unit 20 may be configured to determine a distance from the terminal 100 to another terminal by using intensity information of a signal received by the antenna unit 10.

The direction detecting unit 30 may be configured to obtain a direction or orientation of the terminal 100. The direction detecting unit 30 may include a sensor module to detect the direction or orientation, which may be an electronic compass, a gyroscopic sensor, an acceleration sensor, or the like. A north (N) direction may be detected using the sensor such as an electronic compass. An orientation of the terminal 100 may be detected using the north direction and a twisting angle to the orientation of the terminal 100.

The touch screen 40 may be configured to display information to a user or receive an input from a user or the like. The touch screen 40 may receive a user touch or dragging motion and may receive a designation of another terminal.

The control unit 50 may be configured to calculate a relative location of another terminal by using a triangulation method based on the distance information of other terminals determined by the distance determining unit 20 and a distance information received from the other terminals or a server. The distance information received from the other terminals or the server may include the distance between other terminals or between the terminal 100 and the other terminals. The control unit 50 may be configured to determine the relative location and direction of other terminals based on the orientation of the terminal 100 obtained by the direction detecting unit 30 and the calculated relative distance information of the other terminals.

The server 200 may be configured to collect distance information of the terminal 100 with respect to other terminals, and calculate and store the distance between terminals. The server 200 includes a calculating unit 202 to calculate distances among a plurality of terminals 100 based on the distance information received from distance determining unit 20 of each of the plurality of terminals 100, and a memory unit 204 configured to store the distance information among the plurality of terminals 100 calculated by the calculating unit 202.

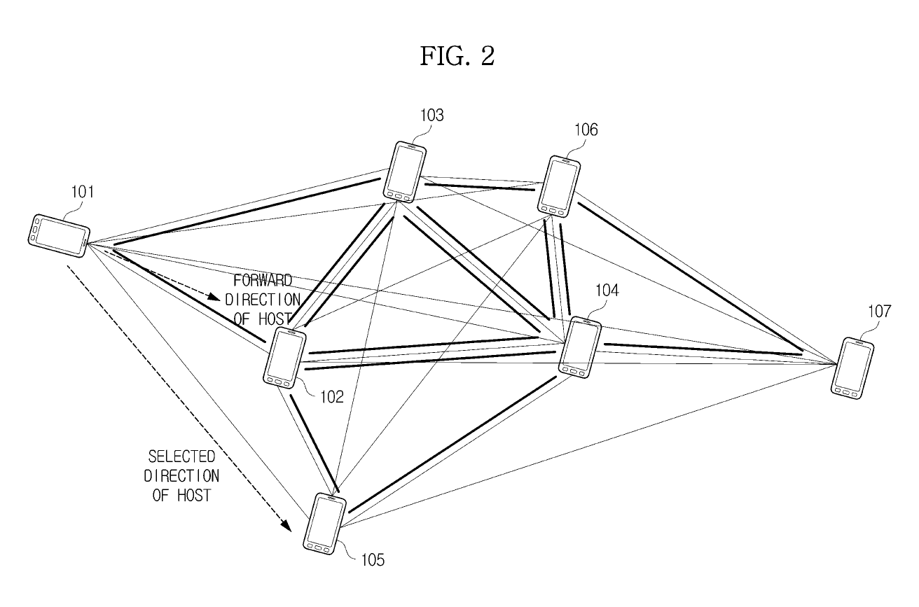

FIG. 2 is a schematic diagram illustrating a localization method according to an exemplary embodiment of the present invention.

Referring to FIG. 2, terminal 101, terminal 102, terminal 103, terminal 104, terminal 105, terminal 106, and terminal 107 may each determine a distance and an orientation relative to each other. As a result, based on its orientation information and distance information, triangles may be drawn and coupled together to form a large group of triangles which may be used to obtain coordinates for each terminal based on the determined distance information.

The terminal used to search for a wireless signal may be referred to as a host terminal, and a terminal found by the host terminal may be referred to as a client terminal. Each terminal 100 may search for a wireless signal of another terminal, and therefore may be a host terminal or a client terminal.

A host terminal 101 may select a specific direction towards one of the client terminals, terminal 102, terminal 103, terminal 104, terminal 105, terminal 106, and terminal 107 to designate a specific client terminal, for example client terminal 105. Since the orientation of the host terminal 101 is determined by the direction detecting unit 30, the designated direction of the client terminal 105 may be determined with respect to the orientation of the host terminal 101.

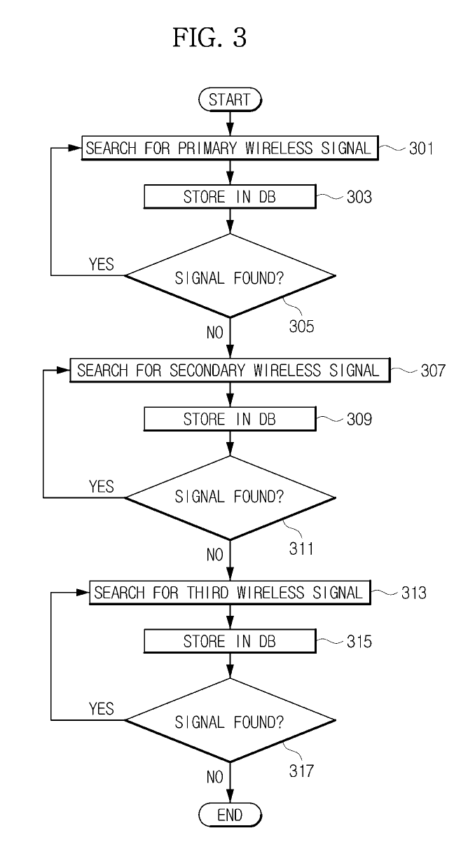

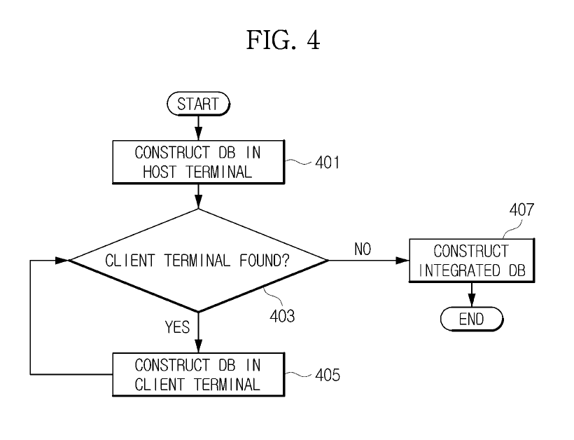

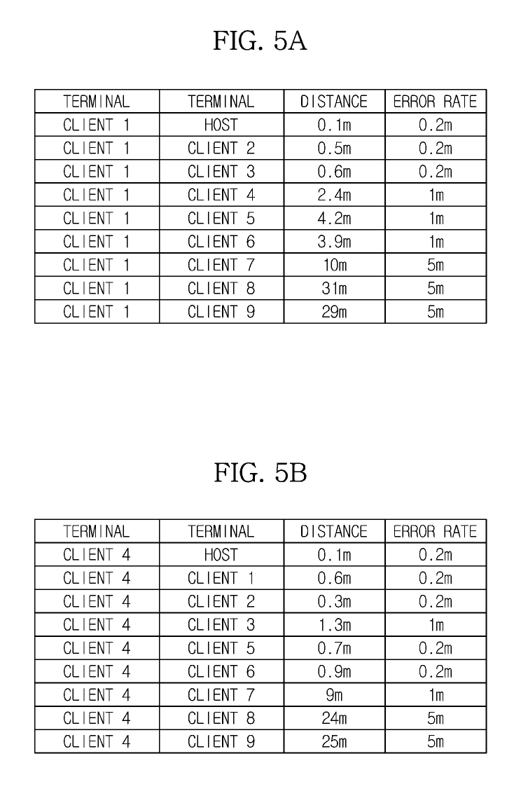

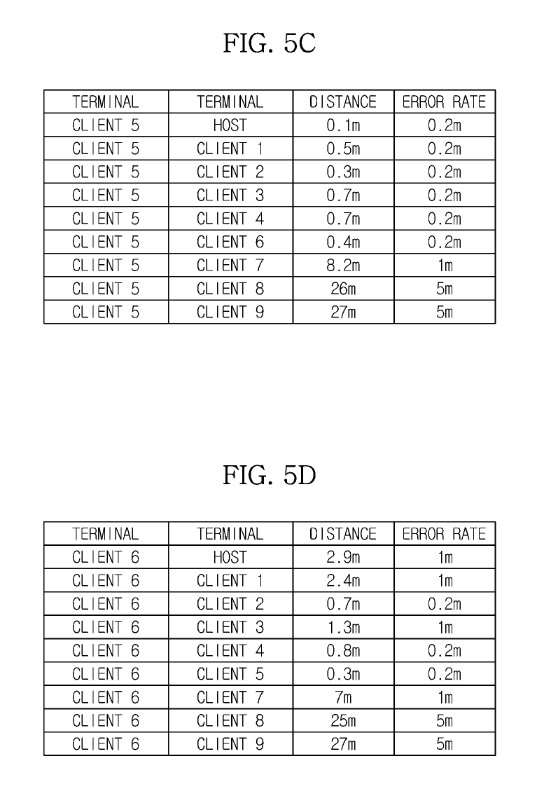

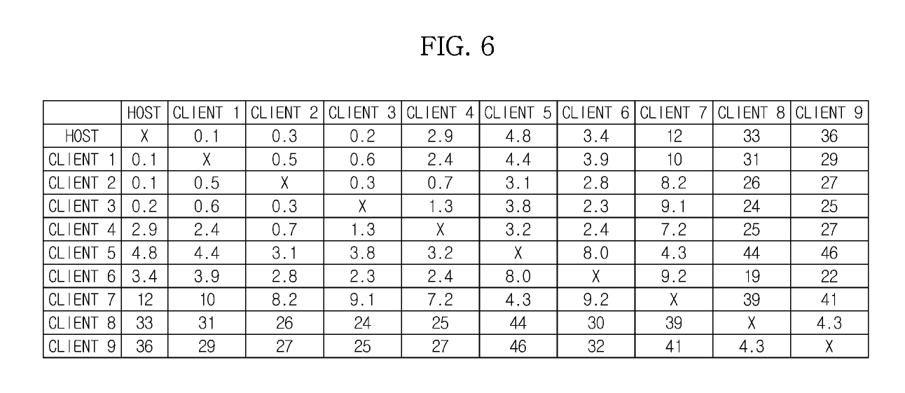

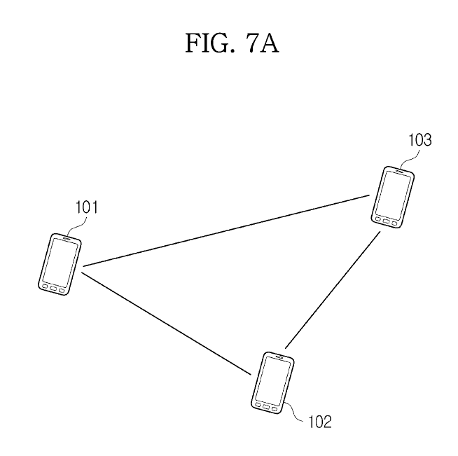

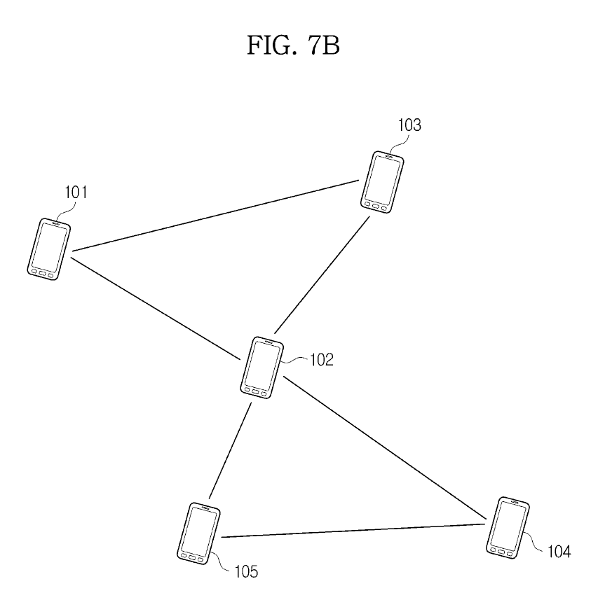

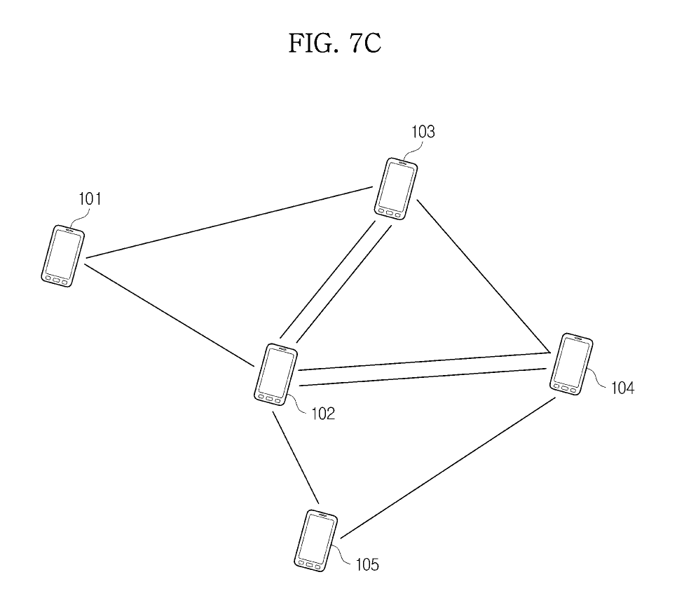

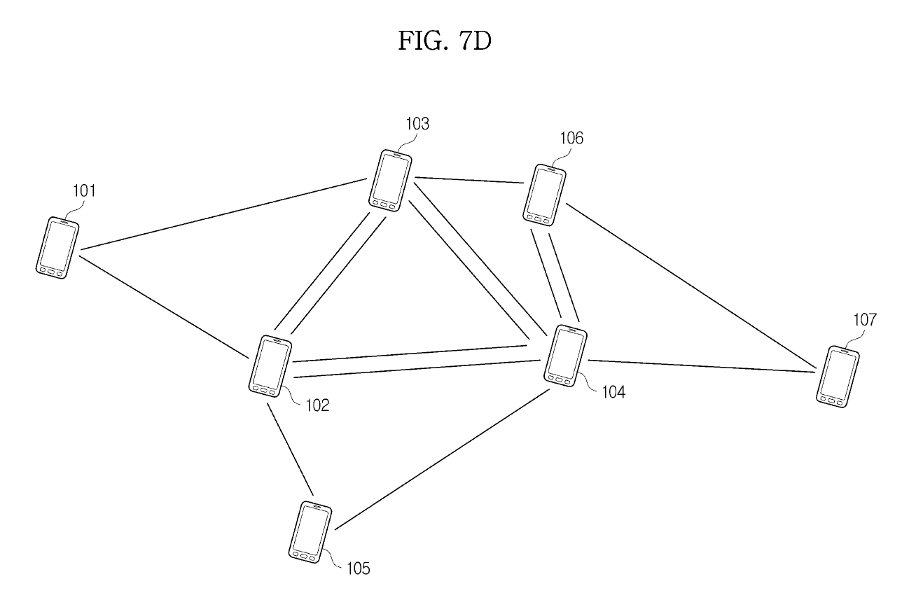

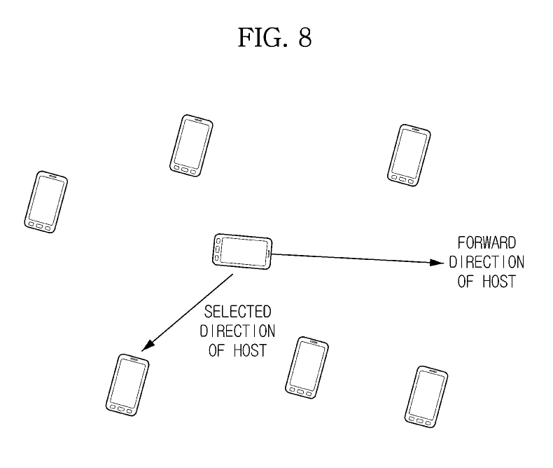

Hereinafter, a method for determining location and direction of a terminal using a triangulation method will be described in detail with reference to FIG. 3, FIG. 4, FIG. 5, FIG. 6, FIG. 7, and FIG. 8.

FIG. 3 is a flowchart illustrating a method for measurement of distance according to an exemplary embodiment of the present invention.

The method of FIG. 3 is described with reference to the terminal 100 of FIG. 1, however, the method is not limited thereto. Referring to FIG. 3, the antenna unit 10 stores distance information to another terminal in a distance information DB while performing a search for a wireless signal using, the first antenna 11, the second antenna 12, and the third antenna 13.

In particular, in operation 301, the first antenna 11 searches for the primary wireless signal of another terminal. In operation 303, the found primary wireless signal information is stored in the distance information DB. The wireless signal information may include the kind and intensity of a wireless signal.

In operation 305, it is determined whether a primary wireless signal was found. If a primary wireless signal is found the method returns to operation 301 and searches for additional primary wireless signals of additional terminals. If no primary wireless signal is found, in operation 307, the second antenna 12 searches for a secondary wireless signal.

In operation 309, the found secondary wireless signal information is stored in the distance information DB. In operation 311, it is determined whether another secondary wireless signal was found. If another secondary wireless signal is found, the method returns to operation 307 and searches for additional secondary wireless signals of additional terminals. If no secondary wireless signal is found, in operation 313, the third antenna 13 searches for a third wireless signal.

In operation 315, the found third wireless signal information is stored in the distance information DB. In operation 317, it is determined whether another third signal was found. If another third signal is found, the method returns to operation 313 and searches for additional third wireless signals of additional terminals. If no third signal is found, the method terminates.

The above described method is performed by terminal 100, and a distance information DB from terminal 100 to each additional terminal is constructed.

Although, a terminal configured to measure the intensities of three wireless signals with different coverage ranges and different margins of error has been described, the invention is not limited thereto, and a terminal configured to measure the intensity of one, two, four, or more wireless signals may also be adopted.

FIG. 4 is a flowchart illustrating a method for performing a distance measurement according to an exemplary embodiment of the present invention.

If multiple terminals are present, in operation 401, one terminal, namely a host terminal, constructs a distance information DB. In operation 403, it is determined whether a client terminal is found. If the client terminal is found, in operation 405, a distance information DB is constructed in the client terminal and the method returns to operation 403 to repeat the process for additional client terminals.

In operation 407, if no additional client terminal was found, the constructed distance information DB of the host terminal and information related to one or more previously identified client terminal are integrated to construct an integrated distance information DB.

The integrated DB may be constructed by receiving the distance information obtained by the client terminals and adding the distance information to the distance information of the host terminal 100. The host terminal 100 may receive the distance information DB directly from client terminals or may receive the distance information from the server 200.

If the host terminal 100 receives the distance information DB directly from client terminals, the host terminal 100 may calculate a relative location of the client terminals based on the received distance information using the triangulation method. The calculation of distance information may increase the processor load of host terminal 100.

The server 200 may collect distance information with respect to the host terminal 100 from a plurality of client terminals and may calculate relative locations of client terminals using a triangulation method, and may transmit the relative location information to the host terminal 100.

FIG. 5A, FIG. 5B, FIG. 5C, and FIG. 5D are tables illustrating distance information observed from each client terminal according to an exemplary embodiment of the present invention.

FIG. 5A is a table showing distance information from client 1 to a host terminal and other client terminals and corresponding error rate information. Similarly, FIG. 5B is a table showing distance information from client 4 to a host terminal and other client terminals and corresponding error rate information. FIG. 5C is a table showing distance information from client 5 to a host terminal and other client terminals and corresponding error rate information. FIG. 5D is a table showing distance information from client 6 to a host terminal and other client terminals and corresponding error rate information.

Referring to FIG. 5A, FIG. 5B, FIG. 5C, and FIG. 5D, each data value in the distance column represents distance information from a client terminal to a host terminal or other client terminals, measured by the client terminal. The distance information may be revised according to various factors. The table illustrating distance information before correction is referred to as a “Native Table,” or “N-Table.” The N-Table contains the measured distance information, namely raw measurement values not corrected or processed. The N-Table may be transmitted to the calculating unit 202 of the server 200 of FIG. 1 with little or no correcting process to decrease a processing load on the client terminal.

If the calculating unit 202 collects the distance information of each terminal, a correction process may be performed and the location information of each terminal may be calculated based on the corrected data using the triangulation method.

In other words, the values of the N-Table generated by each terminal may be used to generate a compensation table (C-Table) which may be corrected based on a reference table (R-Table). The correction may be performed if a difference in distance between two searched terminals is within a margin of error of the signal standard. This correction may be performed according to four principles, described below with reference to FIG. 5A, FIG. 5B, FIG. 5C, and FIG. 5D.

The first principle is that an N-Table measured by a client terminal located between the host terminal and two target client terminals being corrected is weighted more than a table measured by the host terminal. The N-Table of the client terminal between the host terminal and the two target client terminals may become the R-Table. If two or more client terminals are present between the host terminal and the target client terminals, the N-Table of a terminal closest to two target client terminals may be selected as the R-Table.

The second principle is an R-Table may be considered reliable if a distance between two client terminals stored in the R-Table and the same distance between the two client terminals corresponding to the N-Table of the two client terminals are within a reference value of the margin of error of the measured distance in the N-Table. The reference value may be arbitrarily chosen, for example to 50% of the margin of error of a measured distance, and it may be replaced with another reference value.

The third principle is that, if a raw distance measured from the host terminal to two client terminals (N-Table) is compared with a distance between the host terminal and the two client terminals from a reliable R-Table and the distances are different, the distance in the N-Table is replaced with the distance stored in the reliable R-Table.

The fourth principle is that, if there is no R-Table which satisfies the above three principles, the distance observed at the position of the host terminal is maintained.

An application of the four principles will be described with reference to FIG. 5A, FIG. 5B, FIG. 5C, and FIG. 5D, and, in particular, with reference to a system of client 1, client 4, client 5, and client 6. Referring to FIG. 5A, the client 4 is observed to be located closer to client 1 than client 5 and the client 6. Applying the first principle results in the N-Table measured by the client 4, i.e., FIG. 5B, becoming the R-Table.

A reference value of the second principle may be 50% of the margin of error of a measured distance. Referring to FIG. 5B, the distance to the client 5 and to the client 6 observed by the client 4 in the R-Table is within the reference value of the margin of error of the distance to the client 4 observed by the client 5 in FIG. 5C and the distance to the client 4 observed by the client 6 in FIG. 5D. In particular, the difference in the observed distances by client 4 and client 6 is 0.1 m, which is within 50% of the margin of error of this measurement, 0.2 m. Therefore the R-Table, i.e., the N-Table of FIG. 5B may be considered reliable according to the second principle.

Finally, the third principle is demonstrated with respect to a system of client 1, and target client terminals, client 5 and client 6, in which the N-Table of client 4 has been determined to be a reliable R-Table. FIG. 5A illustrates that the client 5 is measured as the client terminal farther away from client 1. However, from the perspective of client 4, located between the client 1, and the target client terminals, client 5 and client 6, the client 5 is measured to be closer to client 4 than the client 6. Therefore, applying the third principle, client 1, recognizes that the client 5 is closer to client 1, than measured by the client 1, and replaces the distance data value associated with client 5 with the distance data value in the R-Table of FIG. 5B. Applying principle four, if no R-Table is determined, the values in the N-Table of the host terminal are maintained.

FIG. 6 is a table illustrating compensation distance data according to an exemplary embodiment of the present invention. In particular, FIG. 6 is a table showing compensation distance data obtained by correcting the results of FIG. 5A, FIG. 5B, FIG. 5C, and FIG. 5D.

The calculating unit 202 of the server 200 may correct data values of the distance information by applying one or more of the four principles using the distance information collected from each terminal, and the table of FIG. 6 shows a C-Table completed based on the corrected values.

FIG. 7A is a schematic illustrating a triangulation method based on compensation distance data according to an exemplary embodiment of the present invention. FIG. 7B is a schematic illustrating a triangulation method based on compensation distance data according to an exemplary embodiment of the present invention. FIG. 7C is a schematic illustrating a triangulation method based on compensation distance data according to an exemplary embodiment of the present invention. FIG. 7D is a schematic illustrating a triangulation method based on compensation distance data according to an exemplary embodiment of the present invention.

Referring to FIG. 7A, if a C-Table is completed, the server 200 forms a triangle by using the distances between the host terminal 101, the client terminal 102, and the client terminal 103. The client terminal 102 and the client terminal 103 may be the closest client terminals to the host terminal 101. Since a triangle having the given three distances is unique, the relative locations of the host terminal 101 and the client terminal 102 and client terminal 103 may be correctly drawn.

The client terminal 102 and the client terminal 103 may form other triangles with additional client terminals by using the distances from the additional client terminals. The server 200 may unite the new triangles to the previously formed triangle. If this process is successively performed the relative locations between the host terminal and the client terminals may be drawn as a diagram similar to the diagram of FIG. 2.

Referring to FIG. 7B, client terminal 104 and client terminal 105 are added to the system of FIG. 7A, and a new triangle is formed with client terminal 102, client terminal 104 and client terminal 105. Since there may be various client terminals which may form triangles with client terminal 102, relative locations of the client terminal 104 and client terminal 105 may vary while still forming a triangle with client terminal 102.

Referring to FIG. 7C, if the distance information from the client terminal 104 to the client terminal 102 and client terminal 103 is verified according to a C-Table, the location of client terminal 104 and client terminal 105 may be determined according on the C-Table data because distance information of client terminal 105 is known with respect to client terminal 102 and client terminal 103 (FIG. 7B). FIG. 7D shows a relative location view of the client terminals based on the host terminal 101, expanded similar to FIG. 7C.

FIG. 8 is a schematic diagram illustrating a host terminal according to an exemplary embodiment of the present invention.

The host terminal 101 may detect an orientation of the host terminal 101 by using a direction detecting unit such as an electronic compass as described above. If an input selecting a specific direction is received, for example if a user drags a finger in a specific direction on a touch screen of the host terminal, the orientation of the selected specific direction may be determined relative to the orientation of the host terminal 101.

Since the relative locations of some client terminals may already be known based on the host terminal, the selection of a specific direction may act to designate a client terminal located along the selected direction.

The designation of a specific client terminal may be useful where linked operations associated with another user are performed if a specific application is operated in the terminal. In other words, if a user inputs a command designating a specific direction to the terminal, a specific terminal corresponding to the designated direction may be designated among other terminals, and a specific command of a specific application may be transmitted to the designated terminal.

For example, by designating a specific direction, during a conference, a specific opponent may be designated so that data is sent to the opponent. In addition, if a multi-player game is played, behaviors such as card dealing or item exchange may be conveniently performed.

According to exemplary embodiments of the present invention, a terminal, a localization system, and a method for determining location may not use a GPS or a DB for a wireless AP which obtains GPS information to determine the location of other terminals. Relative locations of terminals based on a specific terminal may be calculated with the specificity up to the specificity level of GPS or above by combining the intensities of a plurality of wireless signals.

However, the a terminal, a location system and a method for determining location may also use GPS information and wireless AP information to increase the utilization range of the system. For example, if a wireless AP is installed in every shop in a mall, the wireless AP may be utilized as a client terminal. Thus, it may be possible to obtain a distance between the host terminal and the client terminal, as well as an absolute coordinate of the client terminal. Therefore, a user using the host terminal may correctly recognize his/her current location while shopping in the mall or a department store.

The terminal, localization system, and method for determining location according to the exemplary embodiments may provide a localization service indoors, where GPS signals may not easily be received.

In addition, by performing a behavior indicating a specific direction with the terminal according to the present disclosure, it may be possible to designate a specific opponent and send data to the opponent during a conference or to deal cards or exchange items in a multi-player game.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A first terminal, comprising:
an antenna unit to receive a first wireless signal from a second terminal, a second wireless signal from a third terminal, and information about a third wireless signal transmitted between the second terminal and the third terminal;
a distance determining unit to determine distance information of the second terminal and the third terminal with respect to the first terminal, wherein the distance information is determined according to an intensity of the first wireless signal and the second wireless signal;
a direction detecting unit to determine an orientation of the first terminal; and
a control unit to calculate locations of the second terminal and the third terminal based on the orientation of the first terminal and the distance information, and the information about the third wireless signal.

2. The first terminal of claim 1, wherein the antenna unit comprises a first sub-antenna unit and a second sub-antenna unit, the first sub-antenna unit to receive a wireless signal with a first range and the second sub-antenna to receive a wireless signal with a second range.

3. The first terminal of claim 1, wherein the direction detecting unit determines a north direction of the terminal, and the north direction is used to determine the orientation of the terminal.

4. The first terminal of claim 1, further comprising a touch screen to receive a designation of at least one of the second terminal, and the third terminal.

5. The first terminal of claim 1, wherein the wireless signals are each at least one of a radio-frequency identification signal, a Bluetooth® signal, and a WiFi signal.

6. A localization system, comprising:
a first terminal to receive a first set of wireless signals from a second terminal and a third terminal, and to determine distance information of the second terminal and the third terminal with respect to the first terminal according to the first set of wireless signals;
the second terminal to receive a second set of wireless signals from the first terminal and the third terminal, and to determine a distance of the first terminal and the third terminal with respect to the second terminal according to the second set of wireless signals;
the third terminal to receive a third set of wireless signals from the first terminal and the second terminal, and to determine a distance of the first terminal and the second terminal with respect to the third terminal according to the third set of wireless signals; and
a server to receive determined distance information from each of the first terminal, the second terminal, and the third terminal, and to determine a location of the first terminal, the second terminal, and the third terminal.

7. The system of claim 6, wherein the wireless signals are each at least one of a radio-frequency identification signal, a Bluetooth® signal, and a WiFi signal.

8. The system of claim 6, wherein the server determines the location of the first terminal, the second terminal, and the third terminal according to reference information.

9. The system of claim 7, wherein the reference information comprises distance information of the first terminal, the second terminal, and the third terminal with respect to a fourth terminal, and the fourth terminal is located between the first terminal, the second terminal, and the third terminal.

10. The system of claim 7, wherein reference information is determined to be reliable reference information if
a distance between the fourth terminal and the second terminal in the reference information is within a reference value of a margin of error of the distance between the fourth terminal and the second terminal, as determined by the second terminal, and
a distance between the fourth terminal and the third terminal in the reference information is within a reference value of a margin of error of a distance between the fourth terminal and the third terminal, as determined by the third terminal.

11. The system of claim 10, wherein the reference value is at least 50% or less.

12. The system of claim 8, further comprising native information comprising distance information of the second terminal and the third terminal with respect to the first terminal according to the wireless signals.

13. The system of claim 12, wherein if the distance between the second terminal and the first terminal in the native information differs from the distance between the second terminal and the first terminal in the reference information, the distance in the native information is revised to match the reference information.

14. A method for determining a location of a terminal, comprising:
receiving, in a first terminal, a wireless signal from each of a second terminal and a third terminal;
determining, in the first terminal, an intensity of the wireless signal received from the second terminal and an intensity of the wireless signal received from the third terminal;
determining, in the first terminal, a distance to the second terminal according to the intensity of the wireless signal received from the second terminal, and a distance to the third terminal according to the intensity of the wireless signal received from the third terminal;
determining an orientation of the first terminal; and
determining locations of the second terminal and the third terminal based on the orientation of the first terminal, the distance to the second terminal, the distance to the third terminal, and a distance from the second terminal to the third terminal received from one of the second terminal or the third terminal.

15. The method of claim 14, wherein the wireless signals are each at least one of a radio-frequency identification signal, a Bluetooth® signal, and a WiFi signal.

16. The method of claim 14, wherein each of the wireless signals has a different transmission range.

17. The method of claim 14, wherein determining an orientation of the first terminal comprises determining a north direction, and using the north direction to determine orientation of the first terminal.

18. The method of claim 14, wherein the distance from the second terminal to the third terminal is determined according to an intensity of a wireless signal between the second terminal and the third terminal.

19. The method of claim 14, wherein the distance from the second terminal to the third terminal is determined by a server.
